(19) United States
(12) Patent Application Publication
(10) Pub. No.: US 2008/0297766 A1
(43) Pub. Date: Dec. 4, 2008

(54) System and method for measuring fluid aeration

(75) Inventors: Eric Peter Gengler, Chicago, IL (US); Wayne Walter Lark, Joliet, IL (US); Michael Wayne Darin, Crest Hill, IL (US); Joseph Jesse Rodriguez, Coal City, IL (US); David James Didesiderio, Elwood, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/806,386

(22) Filed: May 31, 2007

(51) Int. Cl. G01J 3/00; G01N 21/00

(52) U.S. Cl. 356/51; 356/436

(57) ABSTRACT

An aeration measurement system for a fluid actuation system is disclosed. The aeration measurement system has a container configured to receive fluid, and a light source configured to emit light into the container. The aeration measurement system also has a light receiver that is configured to receive light from the light source while the light is passing through the fluid. The aeration measurement system further has a controller in communication with the light source and light receiver. The controller is configured to determine an amount of aeration in the fluid based on the received light.

### TECHNICAL FIELD

This disclosure relates generally to the measurement of aeration in fluids, and more particularly, to a system and method for measuring the amount of aeration in the operating fluids of actuation systems.

### BACKGROUND

The presence of air in the working fluid of an actuation system such as a hydraulic work tool system can cause considerable performance problems leading to malfunctioning of the system. For example, abnormal noise in a hydraulic system is often caused by aeration. With the hydraulic fluid contaminated by air, loud noise may be heard when the air compresses and decompresses as the fluid circulates through the system. Aeration can also result in severe erosion of pump components when air bubbles present in hydraulic fluids collapse as they suddenly encounter high pressure at the discharge area of the pump. Other common problems caused by fluid aeration can include a lowering of the fluid's bulk modulus, an increase in the fluid's temperature, a loss of lubricity, excessive or premature oxidation of fluid handling components, wasted horsepower, and alteration of the system's natural frequency.

Currently, the amount of aeration of hydraulic fluids is generally measured by collecting a sample of hydraulic fluid and measuring its volume. Any air in the fluid is allowed to escape and the volume of the fluid is measured a second time. The difference in volume is generally considered to be the amount of air present in the fluid. Other methods employed to measure fluid aeration have been sonic velocity and turbidity measurements. However, these methods are generally used in research laboratories and may be impractical for commercial use.

Knowing the amount of aeration in a hydraulic fluid can serve as a diagnostic tool in determining problems in the associated hydraulic system. It may also help prevent problems associated with aeration before they occur by ensuring that the amount of air in the fluid is constantly at an acceptable level.

Various methods for detecting the presence of air in fluids have been developed. These methods are utilized in applications such as introducing medication into patients and processing food and beverages. One example of detecting bubbles in a flowing stream of liquid is described in U.S. Pat. No. 5,455,423 (the '423 patent) issued to Mount et al. on Oct. 3, 1995. The '423 patent utilizes a modulated infra-red (IR) source to detect the presence and size of air bubbles in a fluid. The '423 patent employs a sample tube and focuses the modulated IR source through a bandpass filter onto a venturi in the sample tube. The venturi is illuminated by the modulated IR source to detect the presence of gas bubbles in the fluid. The '423 patent also provides means for determining the size of any detected bubble.

Although the apparatus of the '423 patent may detect the presence of gas bubbles in a fluid and determine a size of the gas bubbles, it does not measure the amount of aeration of the fluid or the amount of gas present in the fluid. Thus, the system described in the '423 patent may be ineffective in situations where the actual amount of air or gas present in the fluid is to be determined or controlled.

This disclosure is directed to overcoming one or more of the problems set forth above.

### SUMMARY OF THE INVENTION

In one aspect, the present disclosure is directed to an aeration measurement system. The aeration measurement system includes a container configured to receive a fluid, and a light source configured to emit light into the container. The aeration measurement system also includes a light receiver, configured to receive light from the light source while the light is passing through the fluid. The aeration measurement system further includes a controller in communication with the light source and light receiver. The controller is configured to determine an amount of aeration in the fluid based on the received light.

In another aspect, the present disclosure is directed to a method of measuring an amount of aeration in a fluid. The method includes directing light through a fluid. The method also includes receiving light while the light is passing through the fluid. The method further includes determining an amount of aeration in the fluid based on the received light.

### BRIEF DESCRIPTION OF THE DRAWINGS

FIG. 1 is a diagrammatic illustration of an exemplary disclosed aeration measurement system.

FIG. 2 is a diagrammatic illustration of an aeration measurement system consistent with certain disclosed embodiments.

### DETAILED DESCRIPTION

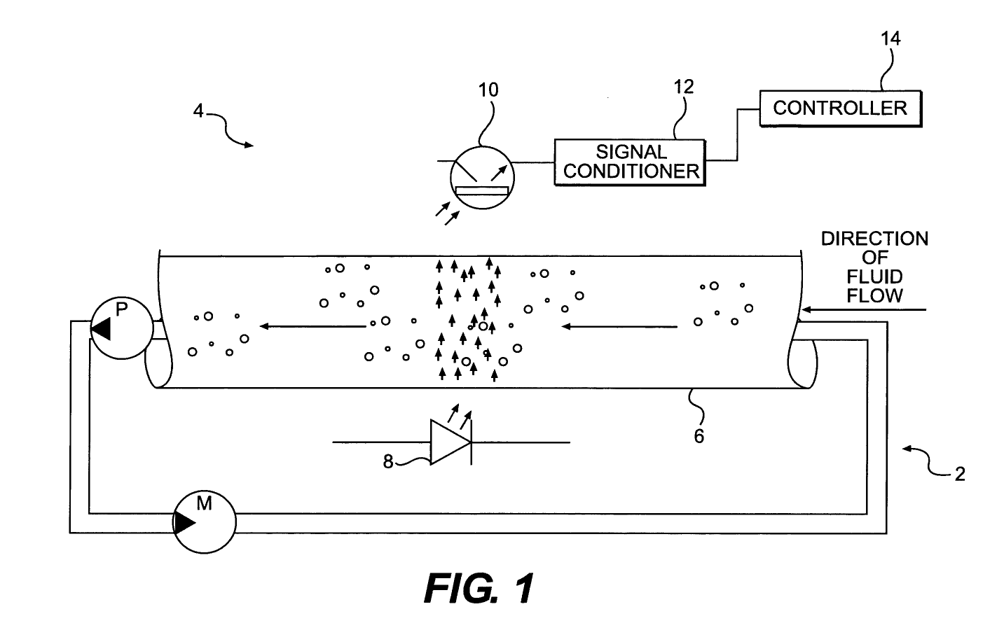

FIG. 1 illustrates an exemplary embodiment of an aeration measurement system 4. Aeration measurement system 4 may be configured to determine an amount of aeration in an associate fluid actuation system 2. Fluid actuation system 2 may include a hydraulic component such as, for example, a hydraulic pump, cylinder, piston, a motor, or any other fluid actuation component connected together in a fluid circuit. Aeration measurement system 4 may be inserted in a fluid path of fluid actuation system 2, such as between a motor and pump.

The aeration measurement system 4 may include a container 6 configured to receive fluid from the fluid actuation system 2. The container 6 may be a tube, pipe, or any other container apparent to one skilled in the art. The container 6 may be generally cylindrical in shape. Container 6 may also have a rectangular shape or any shape apparent to one skilled in the art. The container may further be made of any transparent material that allows light to pass through such as, for example, glass, plastic, or a thin metallic or composite material, or the like.

The aeration measurement system 4 may include a light source 8. Light source 8 may be a light-emitting diode (LED), an infra-red (IR) source, any frequency of light, or any other suitable light source. Light source 8 may be mounted in a location that allows substantially unobstructed shining of light through container 6. Alternatively, light source 8 may be located at a remote location and transmit the light by any appropriate transmission device, such as, for example, fiber optic links, to the container and/or fluid. Light source 8 may have a known frequency. Alternatively, a light source of unknown frequency may be used. If a light source of unknown frequency is used, the frequency of an associated light receiver 10 may be tuned to match the frequency of the light source 8.

Light receiver 10 may be employed by aeration measurement system 4. Light receiver 10 may use a phototransistor, photodiode, or any light receiver apparent to one skilled in the art. The frequency of the light receiver 10 may be tuned to match the frequency of the light source 8. Light receiver 10 may be mounted in a location to receive light that is passing from light source 8 through the fluid. Light receiver 10 may be located in contact with the fluid or, alternatively, external to the container to receive light that is passing through both the fluid and the container. Alternatively, light receiver 10 may be located at a remote location and receive the light passing through the container and/or fluid via any appropriate transmission device, such as, for example, fiber optic links. Light receiver 10 may transmit a signal indicative of the received light to a signal conditioner 12, which may pass a corresponding conditioned signal to a controller 14. Light receiver 10 may alternatively transmit the signal directly controller 14.

Signal conditioner 12 may condition the light received from light receiver 10. That is, signal conditioner 12 may convert the light received by the light receiver 10 into a corresponding voltage or other appropriate signal, such as, for example, pulse-width modulation (PWM), 4-20 mA, or digital data, and may transmit the corresponding voltage to controller 14. Alternatively, signal conditioner 12 may include circuitry that can convert the voltage and/or other appropriate signal into computerized digital data. The computerized digital data may be transmitted to controller 14.

Controller 14 may embody a single microprocessor or multiple microprocessors that include means for receiving signals from the light receiver, digital data, voltage, or any appropriate signal from signal conditioner 12. Numerous commercially available microprocessors can be configured to perform the functions of controller 14. It should be appreciated that the controller 14 could readily embody a general fluid system microprocessor capable of controlling numerous fluid system functions, such as pump and motor control. Controller 14 may include all the components required to run an application such as, for example, a memory, a secondary storage device, and a processor, such as a central processing unit or any other means known in the art for receiving signals from the light receiver, and data and voltage from signal conditioner 12. Various other known circuits may be associated with the controller, including power supply circuitry, signal-conditioning circuitry, solenoid driver circuitry, communication circuitry, and other appropriate circuitry.

Controller 14 may be configured to store calibrated data representing a relationship between the voltage of the signal from signal conditioner 12 to amount of aeration in the fluid of fluid actuation system 2. Alternatively, calibration data may be stored in any other format apparent to one skilled in the art. Controller 14 may include computer hardware configured to determine the amount of aeration in the fluid based on the received light. Controller 14 may also include computer software configured to determine the amount of aeration in the fluid based on the received light. Digital data or appropriate signal received from the signal conditioner 12 may be filtered by controller 14 such that the data may be appropriately compared to the calibration data. Filtering of the data may be done by computer hardware or software.

Container 6, light source 8, and light receiver 10 may be covered and protected by a material that prevents ambient light from seeping through. Any material capable of shielding light may be employed such as, for example, any opaque material. Alternatively, signal conditioner 12 and/or controller 14 may be operably configured to compensate for ambient light.

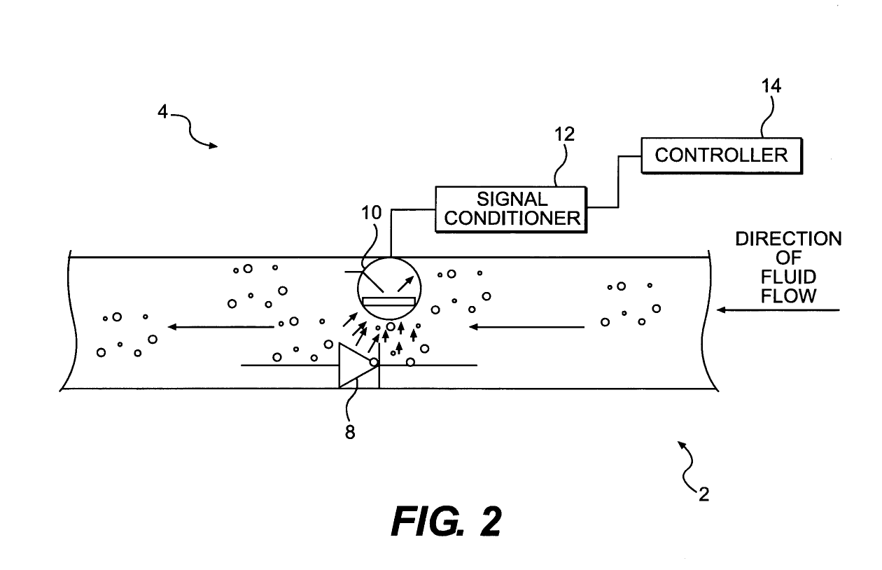

Alternatively, as shown in FIG. 2, light source 8 may be directly embedded in the fluid and configured to shine light through the fluid to light received 10, which may also be embedded in the fluid. Light source 8 may be embedded in a location that allows substantially unobstructed shining of light through the fluid to light receiver 10.

### INDUSTRIAL APPLICABILITY

The disclosed aeration measurement system 4 may be used in conjunction with any fluid actuation system 2, such as a transmission system, an engine lubrication system, a work tool actuation system, or any other pressurized hydraulic system. The disclosed aeration measurement system 4 may provide a mechanism for measuring the amount of air in the working fluid of the system. The operation of aeration measurement system 4 will now be explained in detail.

Fluid from the fluid actuation system 2 may pass through container 6. Alternatively, a sample of the working fluid may be collected and passed through container 6. Light from light source 8 may be directed through the fluid within container 6. While the light is a passing through container 6 and the fluid therein, the light may be received by light receiver 10.

Light receiver 10 may transmit a signal indicative of the received light from the light source 8 to a signal conditioner 12. Signal conditioner 12 may convert the received light into corresponding voltage, other appropriate signal, and/or into computerized digital data. The voltage, other appropriate signal, and/or computerized digital data may be transmitted to controller 14. Controller 14 may filter the voltage, other appropriate signal, and/or digital data and make a comparison with calibrated data to determine the amount of aeration in the fluid.

Care must be taken to ensure that ambient light does not interfere with the light being collected by the light receiver 10. That is, only light directed through container 6 and/or the fluid therein may be collected by light receiver 10. Thus, light source 8, light receiver 10, and container 6 may be covered and protected by material that shields ambient light. Alternatively, signal conditioner 12 and/or controller 14 may be operably configured to compensate for any ambient light.

Generally, aeration in fluids, such as oil, reduces the amount of light that can pass through the fluid. Thus, by passing a known amount of light through the oil and measuring the amount of light that passes through, the aeration of the oil can be determined. Controller 14 may contain calibration data generated by passing various known amounts of light through fluids of varying aeration and determining the amount of light received by light receivers. The resulting data may be used to generate the calibration data. It should be appreciated that calibration data may be generated by any mechanism apparent to one skilled in the art.

Controller 14 may receive the corresponding voltage and determine an amount of aeration in the fluid. Controller 14 may determine the amount of aeration in the fluid by comparing the voltage to calibration data stored in the controller 14.

In another embodiment, light source 8 and light receiver 10 may be completely submerged or embedded in the fluid. In this embodiment, interference from ambient light may not present any concern, because the light from light source 8 may shine directly through the fluid to light receiver 10 also submerged in the fluid.

It will be apparent to those skilled in the art that various modifications and variations can be made to the disclosed aeration measurement system. For example, aeration measurement system may be configured to detect other fluid conditions such as the presence and amount of water and/or other debris in the fluid. Other embodiments will be apparent to those skilled in the art from consideration of the specification and practice of the aeration measurement system. Accordingly, it is intended that the specification and examples be considered as exemplary only, with a true scope being indicated by the following claims and their equivalents.

What is claimed is:

1. An aeration measurement system, comprising:
a container configured to receive a fluid;
a light source configured to emit light into the container;
a light receiver configured to receive light from the light source while the light is passing through the fluid; and
a controller in communication with the light source and light receiver, the controller being configured to determine an amount of aeration in the fluid based on the received light.

2. The system of claim 1, wherein the fluid is oil.

3. The system of claim 1, wherein the light source is an infra-red source.

4. The system of claim 1, wherein the light source is a light emitting diode.

5. The system of claim 1, wherein the container is made of a transparent material.

6. The system of claim 1, wherein the light receiver is a phototransistor.

7. The system of claim 1, further including a signal conditioner configured to convert the received light to a voltage output.

8. The system of claim 7, wherein the controller compares the voltage output to calibrated data stored in the controller and determines the amount of aeration in the fluid based on the comparison.

9. The system of claim 1, wherein at least the container, light source, and light receiver are shielded from ambient sources.

10. The system of claim 1, wherein a frequency of the light source is harmonized with a frequency of the light receiver.

11. A method of measuring an amount of aeration in a fluid, including:
directing light through a fluid;
receiving light while the light is passing through the fluid; and
determining an amount of aeration in the fluid based on the received light.

12. The method of claim 11, further including blocking ambient light.

13. The method of claim 11, further including converting an amount of received light to a corresponding voltage.

14. The method of claim 13, further including comparing the corresponding voltage to calibrated data and determining the amount of aeration in the fluid based on the comparison.

15. The method of claim 11, further including matching a frequency of a light source to a frequency of a light receiver.

16. The method of claim 11, wherein the fluid is oil.

17. An aeration measurement system, comprising:
a light source embedded in fluid and configured to emit light into the fluid;
a light receiver embedded in the fluid and configured to receive light from the light source after the light has passed through the fluid; and
a controller in communication with the light source and light receiver, the controller being configured to determine an amount of aeration in the fluid based on the received light.

18. The system of claim 17 wherein the fluid is oil.

19. A fluid actuation system comprising:
a fluid actuator;
a pump operably connected to the fluid actuator;
a container inserted between the pump and actuator in a path of the fluid;
a light source configured to shine a light through the container and fluid within the container;
a light receiver configured to receive the light while the light is passing through the container and fluid, and to generate a signal in response to the received light;
a signal conditioner configured to process the signal and convert the signal to a corresponding voltage; and
a controller configured to compare the corresponding voltage to calibrated data stored in the controller and determine an amount of aeration in the working fluids based on the comparison.

20. The fluid actuation system of claim 19 wherein the fluid is oil.
